(19) United States
(12) Patent Application Publication
(10) Pub. No.: US 2010/0199759 A1
(43) Pub. Date: Aug. 12, 2010

(54) Fluid Level Sensor and a Method Thereof

(76) Inventor: Dharmaraj Prasad, Coimbatore (IN)

Correspondence Address: DLA PIPER LLP (US), 4365 EXECUTIVE DRIVE, SUITE 1100, SAN DIEGO, CA, 92121-2133, US

(21) Appl. No.: 12/600,822

(22) PCT Filed: May 22, 2008
(86) PCT No.: PCT/IN08/00325

§ 371 Date: Apr. 8, 2010

(30) Foreign Application Priority Data
May 23, 2007 (IN) 01075/CHE/2007

(51) Int. Cl. G01F 23/32

(52) U.S. Cl. 73/317

(57) ABSTRACT

The present invention relates to a fluid level sensor comprising, housing having a snap fit onto which a thick film resistor card is fixed, a shaft with one side of the shaft passing through a wiper arm, at least one washer and a spring to mate with the housing, a housing cover to cover the housing wherein other side of the shaft mates with the cover, and a float arm fixed to the shaft which moves the wiper arm when the fluid level varies, wherein the wiper arm makes contact with the thick film resistor card to indicate the fluid level. The invention further provides a method to detect fluid level. In addition, the invention also provides a method of assembling a fluid level sensor to increase the stability, uniformity, accuracy and repeatability of the sensor over its life.

### CROSS REFERENCE TO RELATED APPLICATIONS

This application is a 35 USC §371 National Stage application of International Application No. PCT/1N2008/000325 filed May 22, 2008, now pending; which claims the benefit under 35 USC §119(a) to India Patent Application No. 01075/CHE/2007 filed May 23, 2007. The disclosure of each of the prior applications is considered part of and is incorporated by reference in the disclosure of this application.

### FIELD OF INVENTION

The present invention relates in general to fuel level sensors of the type in which a fluid-responsive float arm moves a contact wiper over a variable resistance conductive path on a thick film resistor card. The position of the contact wiper on the card corresponds to the level of fuel in the tank as measured by the float. As the wiper moves along the surface of the card, the difference in resistance is measured in an electric circuit indicates the level of liquid fuel in the tank.

### BACKGROUND OF THE INVENTION

Variable resistance fuel level sensors are known in the art for indicating the level of liquid fuel in a vehicle fuel tank. Such fuel sensors typically comprise a housing mounted in the interior of the fuel tank, a resistor card mounted on the housing, a float arm assembly pivotally connected to the housing, and a conductive wiper connected to and operated by the float arm. The conductive wiper has a sliding contact, which moves along the resistive path of the card, and a ground contact to a ground terminal. A positive terminal on the housing supplies electric current to the card with suitable connections from a remote power source.

The resistive path on the card is often accurate, comprising a plurality of conductive pads with varying resistance along the length of the arc. The float arm pivots on an axis approximately coincident with the center of the arc. The float arm assembly includes a bent thin strip float arm with a float mounted at its free end and a pivot pin extending through a hole in the housing.

A plastic support arm on the cover provides stop surfaces, which interact with stops on the housing to define the limit of travel of the float arm and wiper.

A main concern with these types of fuel senders is the need for uniformity, stability and consistency in the fit and operation of the moving parts over the lifetime of the unit.

Relaxation of spring tension, unbalanced moment forces, and inherently weak or unstable mounting and support arrangements can all affect the reliability and repeatability of the readings from the fuel sender unit. Some of the areas particularly critical to reliable and consistent functioning are the sliding wiper interfaces, the spring rates and contact forces of the conductive wiper and the pivot support of the float arm assembly. Reducing the amount of variation, imbalance and loose fit in these areas of the fuel sender greatly increases the unit's reliability and calibration accuracy. None of the prior art to date has adequately and systematically addressed the above-listed factors in a comprehensive manner.

### OBJECTS OF THE INVENTION

One of the principle objects of the invention is to develop a fluid level sensor, a method to measure fluid level and a method of assembling the fluid level sensor.

### STATEMENT OF INVENTION

Accordingly the present invention provides a fluid level sensor, comprising a housing (114) fixed with a thick film resistor card (109) at one end and with a housing cover (103) at other end, a shaft (106) mounted in between the housing (114) and the housing Cover (103) with an end passing through a wiper arm (107), along with at least a washer (108) and a spring (110) to mate with the housing (114), wherein said spring (110) ensures contact in all times and absorbs vibrations caused due to slashing or vibration of a float arm (105) and/or the housing (114), and a float arm (105) fixed to the shaft (106) at one end and with a float at other end, wherein said float arm (105) rotates the shaft (106) which in turn makes sliding contact of the wiper arm (107) with the thick film resistor card (109) to measure the fluid level; the present invention also provides a method to measure fluid level, said method comprises acts of: mounting a thick film resistor card (109) into a housing (114) by a snap fit (112), placing a shaft (106) such that one side of the shaft (106) passes through a wiper arm (107), at least a washer (108) and a spring (110) so as to mate with the housing (114), wherein said spring (110) absorbs vibrations caused due to slashing or vibration of a float arm (105) and/or the housing (114), locking a housing cover (103) with the housing (114), wherein the other side of the shaft (106) mates with the housing cover (103), and fixing a float arm (105) to the shaft (106) to move the wiper arm (107) when the fluid level varies, wherein the wiper arm (107) makes sliding contact with the thick film resistor card (109) to measure the fluid level; and the present invention also provides a method of assembling a fluid level sensor comprising steps of: mounting a thick film resistor card (109) into a housing (114) by a snap fit (112), placing a shaft (106) such that one side of the shaft (106) passes through a wiper arm (107), at least a washer (108) and a spring (110) so as to mate with the housing (114), wherein said spring (110) absorbs vibrations caused due to slashing or vibration of a float arm (105) and/or the housing (114), locking a housing cover (103) with the housing (114), wherein the other side of the shaft (106) mates with the housing cover (103), and fixing a float arm (105) to the shaft (106) to move the wiper arm (107) when the fluid level varies, wherein the wiper arm (107) makes sliding contact with the thick film resistor card (109) to measure the fluid level.

### BRIEF DESCRIPTION OF DRAWINGS

FIG. 1: shows thick film resistor

FIG. 2: shows Assembly view of the instant invention

FIG. 3: shows Exploded view of instant invention

FIG. 4: shows the sub-assembly view of the instant invention

### DETAILED DESCRIPTION OF INVENTION

The primary embodiment of the present is a fluid level sensor, comprising: a housing (114) fixed with a thick film resistor card (109) at one end and with a housing cover at other end, a shaft (106) mounted in between the housing (114) and the housing cover (103) with an end passing through a wiper arm (107), along with at least a washer (108) and a spring (110) to mate with the housing (114), wherein said spring (110) to ensure the contact in all times and absorbs vibrations caused due to slashing or vibration of a float arm (105) and/or the housing (114), and a float arm (105) fixed to the shaft (106) at one end and with a float at other end, wherein said float arm (105) rotates the shaft (106) which in turn makes sliding contact of the wiper arm (107) with the thick film resistor card (109) to measure the fluid level.

In yet another embodiment the shaft (106) mates with the housing (114) through a bush (111) on which the spring (110) is placed.

In still another embodiment the wiper (107) makes the sliding contact with the thick film resistor card (109) by a sweep angle ranging from about 60° to about 110°.

In still another embodiment resistance of the thick film resistor card (109) varies which is proportional to variation in the fluid level.

In still another embodiment the float arm (105) includes a bent strip with a float mounted at its free end which moves with variation of the fluid level.

In still another embodiment the housing cover (103) locks with the housing (114) by snap fit (115).

In still another embodiment the housing cover (103) comprises stoppers (104) to control the sweep angle of the wiper arm (107).

In still another embodiment the thick film resistor card (109) is fixed with the housing (114) using snap fit (112).

Another embodiment of the present invention is a method to measure fluid level, said method comprises acts of: mounting a thick film resistor card (109) into a housing (114) by a snap fit (112), placing a shaft (106) such that one side of the shaft (106) passes through a wiper arm (107), at least a washer (108) and a spring (110) so as to mate with the housing (114), wherein said spring (110) absorbs vibrations caused due to slashing or vibration of a float arm (105) and/or the housing (114), locking a housing cover (103) with the housing (114), wherein the other side of the shaft (106) mates with the housing cover (103), and fixing a float arm (105) to the shaft (106) to move the wiper arm (107) when the fluid level varies, wherein the wiper arm (107) makes sliding contact with the thick film resistor card (109) to measure the fluid level.

In yet another embodiment variation in the sliding contact of the wiper arm (107) with the thick film resistor card (109) varies its resistance.

Another embodiment of the present invention is a method of assembling a fluid level sensor comprising steps of: mounting a thick film resistor card (109) into a housing (114) by a snap fit (112), placing a shaft (106) such that one side of the shaft (106) passes through a wiper arm (107), at least a washer (108) and a spring (110) so as to mate with the housing (114), wherein said spring (110) absorbs vibrations caused due to slashing or vibration of a float arm (105) and/or the housing (114), locking a housing cover (103) with the housing (114), wherein the other side of the shaft (106) mates with the housing cover (103), and fixing a float arm (105) to the shaft (106) to move the wiper arm (107) when the fluid level varies wherein the wiper arm (107) makes sliding contact with the thick film resistor card (109) to measure the fluid level.

In yet another embodiment the shaft (106) mates with the housing (114) through a bush (111) on which the spring (110) is placed.

In still another embodiment the wiper arm (107) is in sliding contact with the thick film resistor card (109) whose resistance variation is proportional to variation of the fuel level.

In still another embodiment the locking of the housing cover (103) with housing (114) is carried out by a snap fit (115).

The fluids used by the instant invention comprises of water, fuels, chemical solvents or reagents and liquefied gases. However, the fluids does not limit to the above mentioned list.

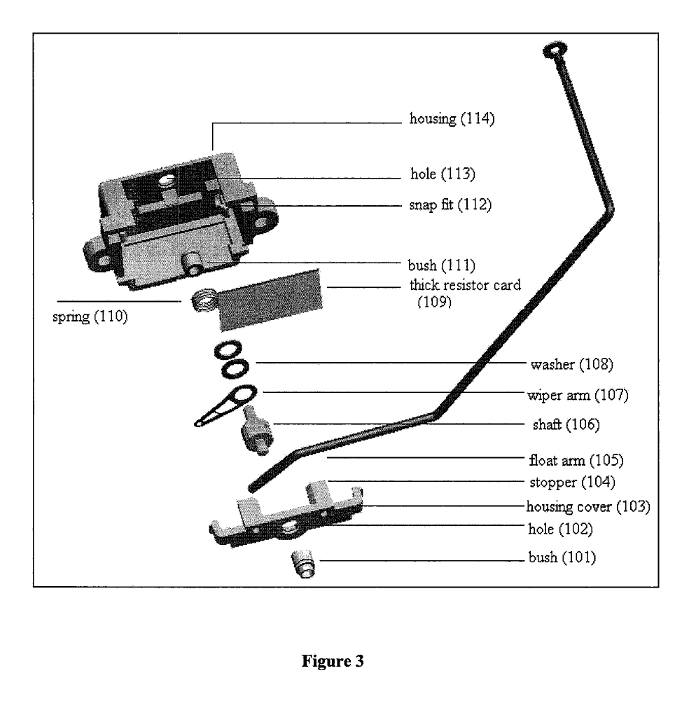

Instant invention is related to fluid level sensor, comprising: a housing (114), a thick film resistor card (109) fixed within the housing (114), a shaft (106) with one side of the shaft (106) passing through a wiper arm (107), at least one washer (108) and a spring (110) to fix with the housing (114) and other side of the shaft (106) mates with a housing cover (103), where the housing cover (103) covers the housing (114), a float arm (105) is fixed to the shaft (106) which carries a float at its free end which varies with the fluid level variation and moves the wiper arm (107) as shown in the FIG. 3. The wiper arm (107) is in contact with the thick resistor card (109).

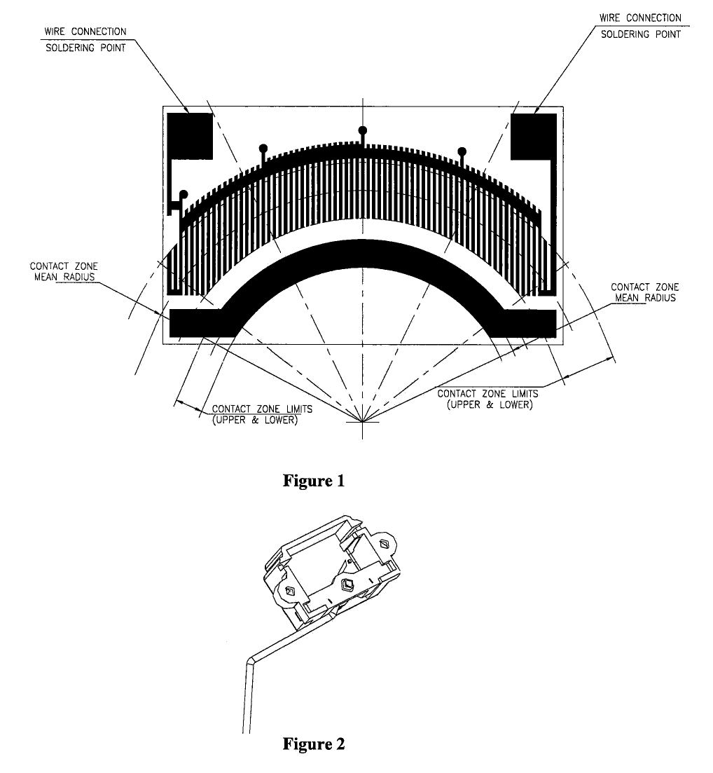

The thick film resistor card (109) is of inverted type as shown in the FIG. 1, by means of which a junction region providing a conductive path from the resistive film to the resistor contact and lead, the junction region being defined by a region surrounding the interface between the contact wiper arm (107) and resistive film, and the resistance varies along the length of the arc for any resistant value as per the requirement of the end user.

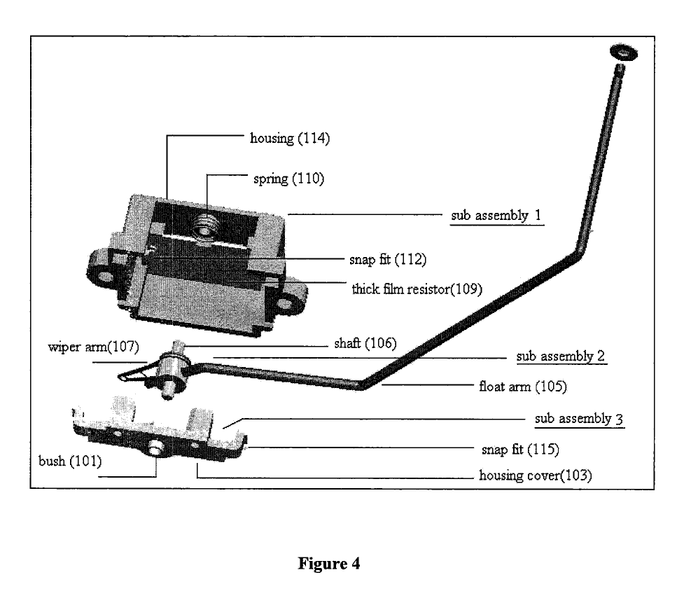

As shown in the FIGS. 3 and 4, the sub assembly 1 consists of the housing (114) wherein the bush (111) is mounted onto a hole (113) of the housing (114) upon which a spring (110) is placed. The thick film resistor card (109) is fixed onto the snap fit (112) of the housing in inverted position. The sub assembly 2 consists of a shaft (106) as a pivot with one side passing through a wiper arm (107) and washers (108). A float arm (105) is fixed on to the shaft (106). This sub assembly 2 is mounted onto the sub assembly 1 such that the shaft (106) is mounted onto the bush (111), spring (110) arrangement. The sub assembly 3 consists of housing cover (103) which locks with the housing (114) by the snap fit (115) and a bush (101).

In sub assembly 2 of FIG. 2, the mentioned float arm (105) includes a bent strip with a float mounted at its free end which varies with the fuel level. With the movement of float arm (105) the shaft (106) move which causes the wiper arm (107) to move. Thus, the wiper arm (107) which is in sliding contact with the thick resistor card (109) varies the resistance of the card (109) proportionately with fuel level variation. The FIG. 2 shows the complete assembly of the fluid level sensor.

The housing (114) arrangement is made stable with the help of spring (110) arrangement. The spring (110) is used to prevent wiper arm (107) from permanent deflection due to slashing or vibration. The fuel level sensors cover (103) absorbs the load due to vibration and positioning itself by moving back and forth in longitudinal direction by means of spring (110). The spring (110) locks the wiper (107) with the shaft (106) and washers (108) so that there is no motion of wiper (107) due to slashing or vibrations. The wiper (107) sweep angle is ranging from about 60° to about 110°. The stoppers (104) on the housing cover (103) control the wiper (107) sweep angle.

1. A fluid level sensor comprising:
a. a housing (114) fixed with a thick film resistor card (109) at one end and with a housing cover at other end,
b. a shaft (106) mounted in between the housing (114) and the housing cover (103) with an end passing through a wiper arm (107), along with at least a washer (108) and a spring (110) to mate with the housing (114), wherein said spring (110) ensures contact in all times and absorbs vibrations caused due to slashing or vibration of a float arm (105) and/or the housing (114), and
c. a float arm (105) fixed to the shaft (106) at one end and with a float at other end, wherein said float arm (105) rotates the shaft (106) which in turn makes sliding contact of the wiper arm (107) with the thick film resistor card (109) to measure the fluid level.

2. The fluid level sensor as claimed in claim 1, wherein the shaft (106) mates with the housing (114) through a bush (111) on which the spring (110) is placed.

3. The fluid level sensor as claimed in claim 1, wherein the wiper (107) makes the sliding contact with the thick film resistor card (109) by a sweep angle ranging from about 60° to about 110°.

4. The fluid level sensor as claimed in claim 1, wherein resistance of the thick film resistor card (109) varies which is proportion to the variation in the fluid level.

5. The fluid level sensor as claimed in claim 1, wherein the float arm (105) includes a bent strip with a float mounted at its free end which moves with variation of the fluid level.

6. The fluid level sensor as claimed in claim 1, wherein the housing cover (103) locks with the housing (114) by the snap fit (115).

7. The fluid level sensor as claimed in claim 1, wherein the housing cover (103) comprises stoppers (104) to control the sweep angle of the wiper arm (107).

8. A method to measure fluid level, said method comprises acts of:
a. mounting a thick resistor card (109) onto a housing (114) by a snap fit (112),
b. placing a shaft (106) such that one side of the shaft (106) passes through a wiper arm (107), at least a washers (108) and a spring (110) so as to mate with the housing (114), wherein said spring (110) absorbs vibrations caused due to slashing or vibration of a float arm (105) and/or the housing (114),
c. locking a housing cover (103) with the housing (114), wherein the other side of the shaft (106) mates with the housing cover (103), and
d. fixing a float arm (105) to the shaft (106) to move the wiper arm (107) when the fluid level varies, wherein the wiper arm (107) makes sliding contact with the thick film resistor card (109) to measure the fluid level.

9. The method as claimed in claim 8, wherein variation in the sliding contact of the wiper arm (107) with the thick film resistor card (109) varies its resistance.

10. A method of assembling a fluid level sensor comprising steps of:
a. mounting a thick film resistor card (109) into a housing (114) by a snap fit (112),
b. placing a shaft (106) such that one side of the shaft (106) passes through a wiper arm (107), at least a washer (108) and a spring (110) so as to mate with the housing (114), wherein said spring (110) absorbs vibrations caused due to slashing or vibration of a float arm (105) and/or the housing (114),
c. locking a housing cover (103) with the housing (114), wherein the other side of the shaft (106) mates with the housing cover (103), and
d. fixing a float arm (105) to the shaft (106) to move the wiper arm (107) when the fluid level varies wherein the wiper arm (107) makes sliding contact with the thick film resistor card (109) to measure the fluid level.

11. The method as claimed in claim 10, wherein, the shaft (106) mates with the housing (114) through a bush on which the spring (110) is placed.

12. The method as claimed in claim 10, wherein the wiper arm (107) is in sliding contact with the thick film resistor card (109) whose resistance variation is proportional to the variation of the fluid level.

13. The method as claimed in claim 10, wherein said locking of the housing cover (103) with the housing (114) is carried out by a snap fit (115).

14. The fluid level sensor as claimed in claim 1, wherein the thick film resistor card (109) is fixed with the housing (114) using snap fit (112).

15. The fluid level sensor as claimed in claim 3, wherein the housing cover (103) comprises stoppers (104) to control the sweep angle of the wiper arm (107).
